(19) United States
(12) Patent Application Publication
(10) Pub. No.: US 2006/0228243 A1
(43) Pub. Date: Oct. 12, 2006

(54) Discharge valve structures for a scroll compressor having a separator plate

(75) Inventors: Zili Sun, Arkadelphia, AR (US); Carlos Zamudio, Arkadelphia, AR (US); Gene Fields, Arkadelphia, AR (US)

Correspondence Address: CARLSON, GASKEY & OLDS, P.C., 400 WEST MAPLE ROAD, SUITE 350, BIRMINGHAM, MI, 48009, US

(73) Assignee: Scroll Technologies

(21) Appl. No.: 11/102,003

(22) Filed: Apr. 8, 2005

(51) Int. Cl. F01C 1/02; F04C 2/00; F01C 1/063; F04C 18/00; F03C 2/00

(52) U.S. Cl. 418/55.1

(57) ABSTRACT

A discharge valve is incorporated into a scroll compressor, and in a boss from a non-orbiting scroll. A valve stop is mounted in the boss, and the boss is sealed within an opening in a separator plate. The present invention provides a discharge valve within a scroll compressor having a separator plate while providing a more simplified construction over the prior art.

### BACKGROUND OF THE INVENTION

In a scroll compressor having a separator plate separating an interior chamber into suction and discharge pressure chambers, a discharge valve is mounted within a boss from the non-orbiting scroll that extends through the separator plate. The present invention thus provides a simplified structure for mounting a discharge valve within the separator plate.

Scroll compressors are becoming widely utilized in refrigerant compression applications. In a scroll compressor, two scroll members each have a generally spiral wrap that interfit to define compression chambers. One of the two scroll members is caused to orbit relative to the other, and as the two orbit, the compression chambers decrease in volume and compress an entrapped refrigerant. The entrapped refrigerant is delivered through a discharge port in a non-orbiting scroll, and into a discharge chamber. A separator plate separates an interior of the compressor housing into suction and discharge pressure chambers. In the prior art, providing a discharge valve, and mounting it within the separator plate has been relatively complex and challenging.

In one prior proposed scroll compressor, a boss extends upwardly from a base of the non-orbiting scroll, and receives the discharge valve. However, the boss is not adequately sealed relative to the separator plate.

### SUMMARY OF THE INVENTION

In a disclosed embodiment of this invention, a simplified discharge valve unit is mounted to extend through an opening in a separator plate. The discharge valve is preferably mounted in a boss extending upwardly from a rear of the base of the non-orbiting scroll. This boss extends entirely through an opening in the separator plate. The discharge valve holder also communicates with the discharge port in the non-orbiting scroll. A valve stop is mounted as part of the discharge valve, and the valve stop is preferably force-fit into the boss. The valve stop includes flow passages such that refrigerant can flow into a central portion of the valve stop, to assist in rapidly closing the valve at compressor shutdown.

These and other features of the present invention can be best understood from the following specification and drawings, the following of which is a brief description.

### BRIEF DESCRIPTION OF THE DRAWINGS

FIG. 1 shows a first embodiment.

FIG. 2 shows a valve stop.

FIG. 3 is a perspective view of the valve stop.

FIG. 4 shows a second embodiment.

### DETAILED DESCRIPTION OF THE PREFERRED EMBODIMENT

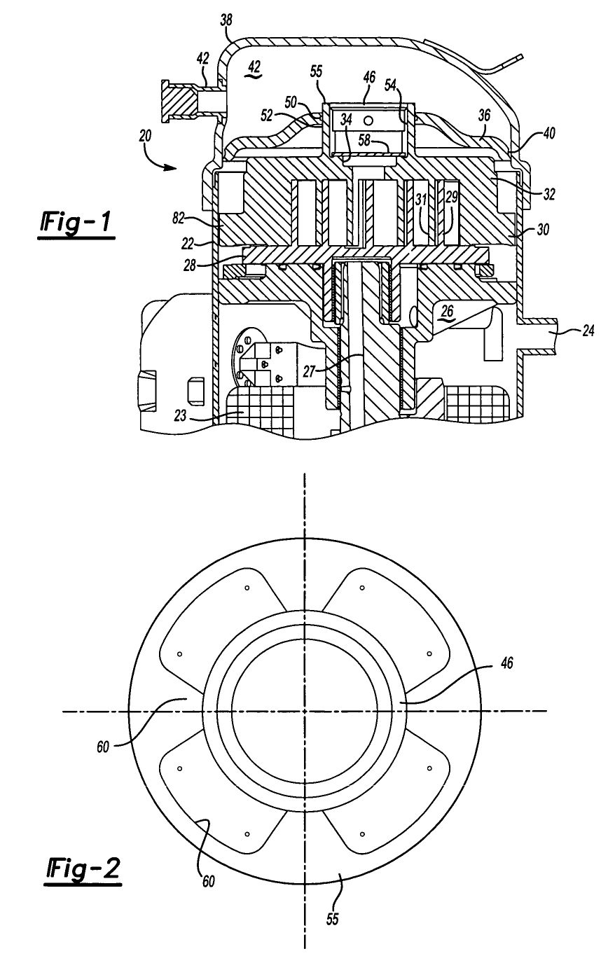

A scroll compressor 20 is illustrated in FIG. 1. As known, a housing 22 receives an electric motor 23, and a suction tube 24 allows suction pressure refrigerant to enter a suction pressure chamber 26.

An orbiting scroll 28 is caused to orbit by a rotating shaft 27. A generally spiral wrap 29 extends from a base of the orbiting scroll. A non-orbiting scroll member 30 has a base 32 and a general spiral wrap 31 interfitting with the generally spiral wrap 29. A discharge port 34 extends through the base of the non-orbiting scroll.

An end cap 38 receives a discharge tube 42. A separator plate 36 is sealed at 40 to the end cap 38, and defines a discharge pressure chamber 42 on one side, and the suction pressure chamber 26 on an opposed side.

A valve stop 46 is force-fit into an opening 54 in a boss 55 extending from the base 32. A seal 50 is provided to seal an interface between this boss 55 and an opening 52 in the separator plate 36. Valve stop 46 stops movement of valve plate 58.

As shown in FIG. 2, the valve stop 46 is force-fit within the boss 55. Stops 60 contact an outer peripheral surface of the valve stop 56, while openings 60 allow flow of refrigerant into the discharge pressure chamber 42.

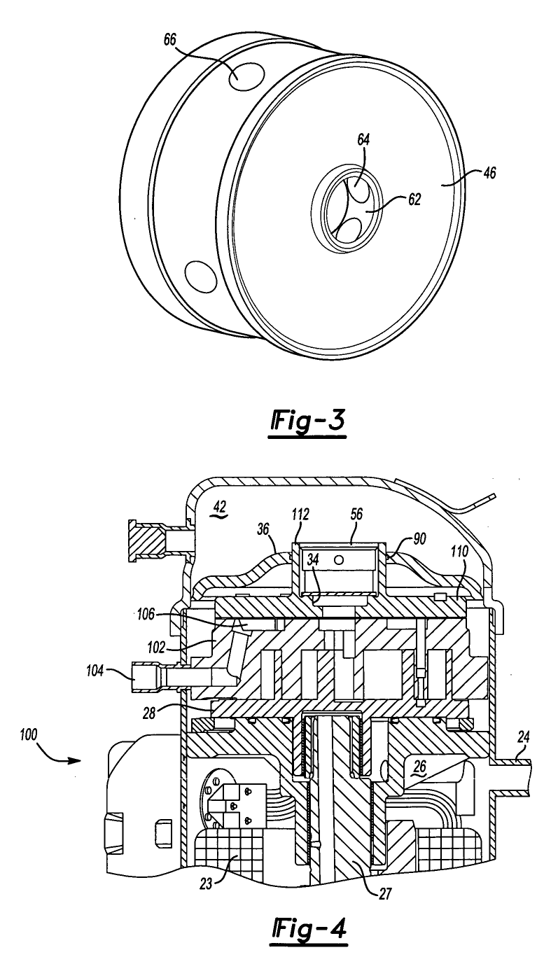

As shown in FIG. 3, the valve stop 46 receives refrigerant passing into openings 66, and then through passages 64 radially inwardly into a central opening 62. The refrigerant from central opening 62 moves the valve plate 58 to a closed position quickly at compressor shutdown.

FIG. 4 shows another embodiment 100. In this embodiment, the fixed scroll 102 receives an intermediate pressure refrigerant, such as an economizer injection fluid through a port 104. Refrigerant passes through passages 106, as is known. A plate 110 is bolted to the rear surface of the fixed scroll 102, and this plate 110 carries the valve holding boss 112. Again, a seal 90 seals between the separate plate 36 and the valve holding boss 112.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A scroll compressor comprising:
a first scroll member having a base and a generally spiral wrap extending from said base;
a second scroll member having a base and a generally spiral wrap extending from its base, said generally spiral wraps of said first and second scroll members interfitting to define compression chambers;
an electric motor driving a rotary shaft, said rotary shaft being connected to cause said second scroll member to orbit;
a discharge port extending through said first scroll member;
a separator plate, said separator plate being fixed within a housing, said housing enclosing said first and second scroll members and said electric motor, said separator plate defining a discharge pressure chamber on a side opposed to said first scroll member and a suction pressure chamber, a suction port extending through said housing to allow suction pressure refrigerant to surround said electric motor and pass into said compression chambers, said discharge port communicating with said discharge pressure chamber; and
said separator plate having a central opening, a boss extending from said base of said first scroll member, through said central opening into said discharge pressure chamber, a discharge valve mounted within said boss and communicating with said discharge port.

2. The scroll compressor as set forth in claim 1, wherein a valve stop is mounted as part of said discharge valve.

3. The scroll compressor as set forth in claim 2, wherein said valve stop is force-fit within said boss.

4. The scroll compressor as recited in claim 2, wherein said valve stop has an end face for providing a stop surface for a valve body, and flow openings to allow discharge pressure refrigerant to flow through said valve stop, and radially inwardly to assist in moving said valve body to a closed position.

5. The scroll compressor as recited in claim 4, wherein said boss has a boss central opening to receive said valve stop, said boss central opening having radially spaced surfaces to define flow passages for communicating refrigerant to said discharge pressure chamber, and stops for contacting an outer peripheral surface of said valve stop.

6. The scroll compressor as recited in claim 1, wherein said boss is an integral part of said base of said first scroll member.

7. The scroll compressor as recited in claim 1, wherein a separate plate is fixed to said first scroll member, and said boss is part of said separate plate.
